(19) United States
(12) Patent Application Publication
(10) Pub. No.: US 2001/0035688 A1
(43) Pub. Date: Nov. 1, 2001

(54) Motor coil-shorting detecting unit

(76) Inventors: Mamoru Sawada, Yokkaichi-city (JP); Masao Isobe, Hamamatsu-city (JP)

Correspondence Address: LAW OFFICE OF DAVID G POSZ, 2000 L STREET, N.W., SUITE 200, WASHINGTON, DC, 20036, US

(21) Appl. No.: 09/816,745

(22) Filed: Mar. 26, 2001

(30) Foreign Application Priority Data
Apr. 27, 2000 (JP) 2000-127368

(51) Int. Cl. H02K 11/00

(52) U.S. Cl. 310/68 C

(57) ABSTRACT

a motor coil-shorting detecting unit is provided which determines the existence of a short. The coil shorting detecting unit includes a current sensor for detecting the value of current supplied to a motor from a power source, and a controller for making the shorting determination of coils by comparing a detected voltage or current with a pre-stored normal voltage or current.

### CROSS-REFERENCE TO RELATED APPLICATION

The present invention is related to Japanese patent application No. 2000-127368, filed Apr. 27, 2000; the contents of which are incorporated herein by reference.

### FIELD OF THE INVENTION

The present invention relates to a coil short detecting unit, and more particularly, to a coil short detecting unit that detects the existence of a coil short in a motor.

### BACKGROUND OF THE INVENTION

Conventionally, a coil short in a DC motor is detected by using a sensor magnet, a Hall element, a controller or the like. Here, the sensor magnet, magnetized at multiple poles in the direction of rotation, is provided on a rotation shaft. The Hall element detects the rotation speed of the rotation shaft by detecting magnetic field changes due to the rotation of the sensor magnet. The controller determines a coil short by detecting rotation speed change due to the coil short. However, positioning the Hall element relative to the sensor magnet is difficult, and attachment requires high accuracy. Further, two parts, the sensor magnet and the Hall element, must be mounted, thereby increasing the number of parts and assembly steps. This increases manufacturing cost.

Furthermore, since the rotation-speed difference is small between normal operation and operation with a coil-short when the motor has no or light load, a coil short might not be detected during such or may be delayed until the load increases.

### SUMMARY OF THE INVENTION

In light of these and other drawbacks, the present invention provides a motor coil-shorting detecting unit that includes a motor having a wire wrapped about its rotor, a detecting means for detecting current or voltage supplied to the motor from a power source, and a determining means that determines a coil short. In the motor, external electric power is supplied to the rotor, for rotation thereof, through a commutator provided on the rotor and a brush that slides over the commutator. The determining means determines shorting by comparing the detected current or voltage with a pre-stored current or voltage supplied from the power source. As such, the detecting means detects the current or the voltage supplied to the motor from the power source, and the determining means determines a short of the coils by comparing the detected voltage or current and the pre-stored voltage or current supplied from the power source during normal operation. Therefore, one detecting means is provided. Furthermore, since shorting is determined based on the current or voltage varied due to motor rotation, shorting is determined irrespective of motor load.

In another aspect, the determining means determines a short based on ripple variations of the current value or voltage value supplied to the motor from the power source in. Here, the ripple variations are detected through the detecting means. Therefore, a short is determined based on the ripple variations of the current or voltage supplied to the motor from the power source. Here, the ripple variations during normal operation and those during a short are different.

In another aspect, the determining means includes a temperature correction circuit for correcting any pre-stored reference current value or voltage value supplied from the power source during normal operation according to a circumferential temperature. Therefore, the determining means includes the temperature correction circuit for correcting the pre-stored current or voltage reference supplied from the power source during normal operation. According to another aspect, the stop control means stops power supply for the motor when the determining means determines that the coils has shorted.

In another aspect, an abnormality informing means is provided for informing a user of motor abnormality when the coil shorting is determined by the determining means. Therefore, the abnormality informing means informs a user of motor abnormality when it is determined by the determining means that the coils has shorted. A stop control means for stopping power supply for the motor when the coil shorting is determined by the determining means is provided.

Further areas of applicability of the present invention will become apparent from the detailed description provided hereinafter. It should be understood that the detailed description and specific examples, while indicating preferred embodiments of the invention, are intended for purposes of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description and the accompanying drawings, wherein:

FIG. 1 is a schematic view for a controller for a motor according to an embodiment of the present invention;

FIG. 2 is a schematic view of a motor according to the present invention;

FIG. 3A is a graph showing current variations during motor rotation for a normal case according to the invention;

FIG. 3B is a graph showing current variations during motor rotation for coil shorting according to the invention;

FIG. 4A is a graph of a current value during motor rotation during normal operation; and

FIG. 4B is a graph of a current value during motor rotation during coil shorting.

### DETAILED DESCRIPTION OF THE INVENTION

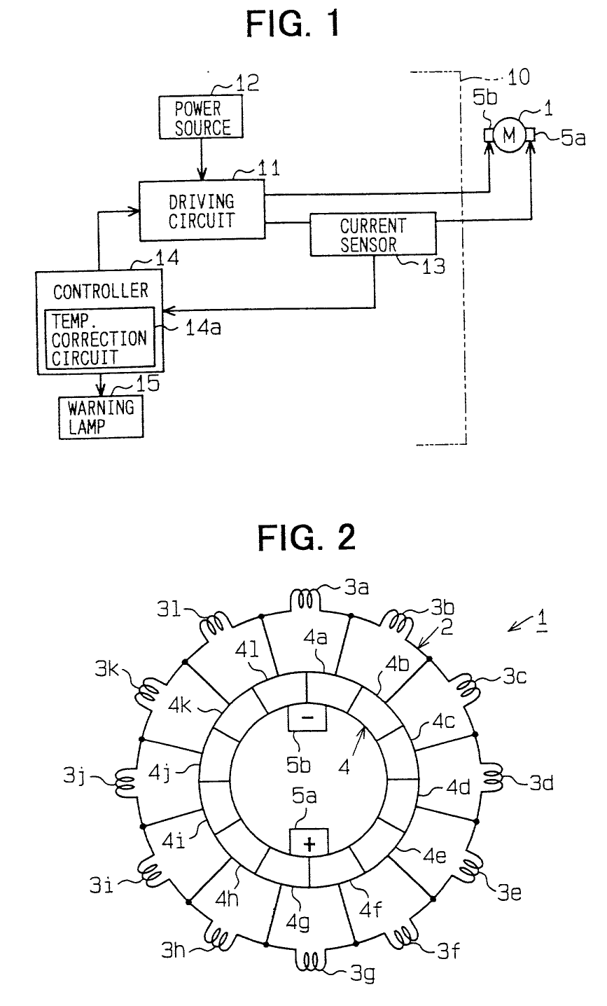

As shown in FIG. 2, a rotor 2 of the motor 1 is provided with coils 3a-3l forming twelve magnetizing coils and a commutator 4 including twelve commutator segments 4a-4l. Both ends of each of the coils 3a-3l are connected to neighboring commutator segments 4a-4l, respectively. The motor 1 has an anode brush 5a and a cathode brush 5b that slides over the commutator 4 (commutator segments 4a-4l). Electric power is supplied to the brushes 5a, 5b from a controller 10 as shown in FIG. 1.

The controller 10 has a driving circuit 11, and driving power is supplied to the driving circuit 11 from a power source 12. The driving circuit 11 is provided with first and second terminals. The first terminal is connected to the anode brush 5a through a current sensor 13, and the second terminal is connected to the cathode brush 5b. The current sensor 13 is provided between the driving circuit 11 and the anode brush 5a through a coupling cable. The driving circuit 11 is controlled by the controller 14. That is, the driving circuit 11 supplies driving power to the brushes 5a, 5b based on the control of the controller 14, thereby controlling the rotation speed of the motor 1.

Detection signals from the current sensor 13, based on values of current supplied to the motor 1 (anode brush 5a) by the driving circuit 11, are input to controller 14. The controller 14 determines whether or not the coils 3a-3l has shorted based on the input detection signals.

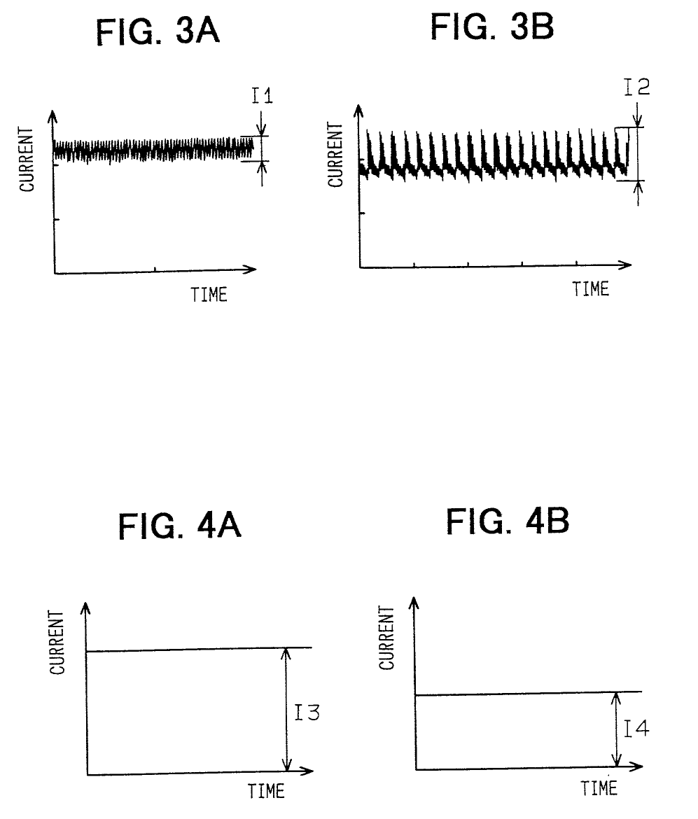

Here, FIG. 3A shows variations (ripple) of the current supplied to the motor 1 when the motor 1 rotates when all of the coils 3a-3l are normal (the coils 3a-3l are not shorted). In the same drawing, an average current variation (in the present embodiment, an average variation of a ripple which is a minimum current value out of a max current value per unit rotation) is indicated by “I1”. On the other hand, FIG. 3B shows the variations of the current when the motor 1 rotates when at least one of the coils 3a-3l is shorted. In the same drawing, the average current variation is indicated by “I2” which is larger than “I1”. The reason is that current routes are changed between the original case (normal case) and when coils 3a-3l are shorted.

In the controller 14, the average current variation “I1” during normal operation is stored as a first reference value. When an average current variation supplied to the motor 1 becomes higher than an upper limit determination value, set slightly higher than the first reference value “I1”, based on the detection signals from the current sensor 13, the controller 14 determines that at least one of the coils 3a-3l is shorted. Here, the controller 14 is provided with a temperature correction circuit 14a. Then, the stored first reference value “I1” is corrected by the temperature correction circuit 14a according to a circumferential temperature, thereby reducing adverse effects on determination due to circumferential temperature variations.

When the average current variation supplied to the motor 1 becomes less than a lower limit determination value, set slightly less than the first reference value “I1”, motor 1 is determined to be under a rotation constraint condition due to its load. FIG. 4A shows a current value during the motor rotation constraint due to its load in the normal case (when coils 3a-3l are not shorted). In the same drawing, the current value is indicated by “I3”. On the other hand, FIG. 4B shows a current value during the motor rotation constraint due to its load during shorting of the coils 3a-3l. In the same drawing, the current value is indicated by “I4” which smaller than normal. The reason is also that current routes are changed between the original case (normal case) shorting of coils 3a-3l.

In the controller, the current value “I3” during a normal state is stored as a second reference value. When current variation is lower than the lower limit value and becomes less than a determination value, set slightly less than a second reference value “I3”, at least one of the coils 3a-3l is determined to be shorted. The stored second reference value “I3” is corrected according to a circumferential temperature by the temperature correction circuit 14a provided in the controller 14, thereby reducing adverse effects for determination due to the circumferential temperature variations. When the controller 14 determines that the coils 3a-3l are shorted in this manner, the controller 14 stops power supply to motor 1 from driving circuit 11, and turns on a warning lamp 15.

(1) The current sensor 13 detects the value of the current supplied to the motor 1 from the power source, and the controller 14 determines a short of the coils 3a-3l by comparing the detection result from the current sensor 13 and the pre-stored current value supplied from the power source.

(2) The controller 14 is provided with the temperature correction circuit 14a for correcting the pre-stored reference current value supplied from the power source during normal operation according to a circumferential temperature. Therefore, the adverse effect on determination due to circumferential temperature variations is reduced by the temperature correction circuit 14a.

(3) When the controller 14 determines that any one of the coils 3a-3l has shorted, the controller 14 stops power supply for the motor 1.

(4) In the present embodiment, the warning lamp 15, which informs a user that the motor 1 is malfunctioning when the controller 14 determines that the coils 3a-3l has shorted, is provided.

The embodiment of the present invention can be modified at least in the following manners.

In the above embodiment, the shorting is determined by using an average variation of a value which is a minimum value out of a maximum value per unit rotation. However, without limitation to this manner, shorting can be determined by using an average current variation per unit time, for example. Further, shorting can be determined by using maximum or minimum current value, or the both.

In the above embodiment, the current sensor is provided between the driving circuit 11 and the anode brush 5a trough the coupling cable. However, the current sensor 13 can also be provided on the driving circuit 11.

In the above embodiment, the current sensor 13 detects the value of the current supplied to the motor 1 from the power source. However, a shunt resistor is provided at the same position as in the current sensor 13, and the shorting determination can be made by using a voltage between both ends of the shunt resistor.

In the above embodiment, the controller 14 is provided with the temperature correction circuit 14a which corrects the predetermined reference current value supplied from the power source according to a circumferential temperature. However, the controller 14 may not be provided with the temperature correction circuit 14a.

In the above embodiment, when the controller 14 determines that the coils 3a-3l have shorted, the controller 14 stops power supply for the motor 1. However, the controller 14 does not need to stop power supply. In the above embodiment, the warning lamp 15, which informs a user of motor 1 malfunction when coils 3a-3l are shorting, is provided. However, sounds from a buzzer or the like other than the lamp 15 can be used.

While the above-described embodiments refer to examples of usage of the present invention, it is understood that the present invention may be applied to other usage, modifications and variations of the same, and is not limited to the disclosure provided herein.

1. A motor coil-shorting detecting unit, comprising:
a motor including a rotor having a wire wrapped around said motor;
a commutator provided on the rotor;
a brush that slides over the commutator, electric power being supplied to the rotor from an external power source via the commutator and brush to rotate the rotor;
a detecting means that detects a current or a voltage supplied to the motor from a power source;
a determining means that determines a short of the motor coils by comparing the detected voltage or current obtained by the detecting means with a respective pre-stored voltage or current, said pre-stored voltage or current representative of that supplied from the external power source during a normal state.

2. The motor coil-shorting detecting unit according to claim 1, wherein:
the determining means makes determines the short based on ripple variations of the current or voltage supplied to the motor from the external power source, the ripple variations being detected by the detecting means.

3. The motor coil-shorting detecting unit according to any one of claims 1, 2, wherein:
the determining means includes a temperature correction circuit for correcting the pre-stored current or voltage according to a circumferential temperature.

4. The motor coil-shorting detecting unit according to any one of claims 1-3, further comprising:
an abnormality informing means for informing a user when the short is determined by the determining means.

5. The motor coil-shorting detecting unit according to any one of claims 1-4, further comprising:
a stop control means for stopping power supply to the motor when the short is determined by the determining means.

6. A motor coil-shorting detecting unit, comprising:
a motor including a plurality of coils;
a commutator provided on the rotor that electrically communicates with the coils;
a brush that slides over the commutator, electric power being supplied from an external power source to the coils via the commutator and brush to rotate the rotor;
a current detector that detects a current supplied to the coils from the power source;
a determing device that compares the detected current with a pre-stored current, said pre-stored current representative of a current supplied by said power source and used by said motor when no short exists; and
an indication device responsive to said determining device that indicates when said short exists.

7. A method for determining a short in a motor coil of a motor supplied from a power source, said method comprising the steps of:
detecting a current supplied to the motor coil;
comparing the detected current with a pre-stored current, said pre-stored current representative of a current supplied to said motor coil when no short of said motor coils exists; and
determining whether a short exists based on said comparing step.
